(19) United States
(12) Patent Application Publication
(10) Pub. No.: US 2006/0161610 A1
(43) Pub. Date: Jul. 20, 2006

(54) Device and method for generating a sequence of numbers

(75) Inventors: Rainer Goettfert, Munich (DE); Berndt Gammel, Markt Schwaben (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/197,776

(22) Filed: Aug. 3, 2005

(30) Foreign Application Priority Data
Aug. 4, 2004 (DE) 10 2004 037 814.2

(51) Int. Cl. G06F 7/58

(52) U.S. Cl. 708/250

(57) ABSTRACT

A random number generator for generating a sequence of numbers comprises a first shift register with a nonlinear feedback, a first number of memory cells and a first output coupled to the first number of memory cells by a first coupling means. Further, the number generator comprises a similarly constructed second shift register as well as a combiner for combining the first data sequence at the first output and the second data sequence at the second output to obtain the sequence of numbers.

### CROSS-REFERENCE TO RELATED APPLICATION

This application claims priority from German Patent Application No.102004037814.2, which was filed on Aug. 4, 2004 and is incorporated herein by reference in its entirety.

### BACKGROUND OF THE INVENTION

1. Field of the Invention

The present invention relates to number generators and particularly to pseudo random number generators, which can for example be used as key generators.

2. Description of the Related Art

A known random number generator is illustrated in FIG. 7. The pseudo random number generator of FIG. 7, which is also referred to as linear feedback shift register, comprises a plurality of memory elements 51, 52, 53, 54, numbered from 0 to n in FIG. 7. Memory cells can be initialized to an initial value via an initialization means 55. Together, the memory cells 51 to 54 form a feedforward means, while the linear shift register formed by memory cells 51 to 54 is fed back via a feedback means, coupled between an output 56 of the circuit and the memory cell n. In particular, the feedback means comprises one or several combination means 57, 58, which are fed by respective feedback branches 59a, 59b, 59c as illustrated exemplarily in FIG. 7. The output value of the last combination means 58 is fed into the memory cell n, designated by 54 in FIG. 7.

The linear feedback shift register shown in FIG. 7 is operated by a clock, so that the occupancy of the memory cells is shifted towards the left with regard to FIG. 7 by one stage in every clock cycle, so that the state stored in the memory means 51 is output as a number in every clock cycle, while at the same time the value is fed into the first memory unit n of the sequence of memory units at the output of the last combination means 51. Thus, the linear feedback shift register illustrated in FIG. 7 provides a sequence of numbers in response to a sequence of clock cycles. The sequence of numbers obtained at output 56 depends on the initial state, which is established by the initialization means 55 prior to the start-up of the shift register. The initial value input by the initializing means 55 is also referred to as a seed, which is why such arrangements illustrated in FIG. 7 are also referred to as seed generators.

The sequence of numbers obtained at the output 56 is referred to as pseudo random sequence of numbers, since the numbers seem to follow each other in a seemingly random way, but are overall periodical although the period is long. Additionally, the sequence of numbers can be repeated unambiguously and thus it has a pseudo random character when the initializing value fed to the memory elements by the initializing means 55 is known. Such shift registers are used, for example, as key stream generators to provide a stream of encoding/decoding keys depending on a specific initializing value (seed).

Such shift registers illustrated in FIG. 7 have the disadvantage of a low linear complexity. Thus, 2 n bits of the output sequence are sufficient to calculate the entire sequence in an n bit LFSR (LFSR=linear feedback shift register). The advantage of such known LFSRs illustrated in FIG. 7, however, is that they incur very low hardware costs.

Additionally, there are irregularly clocked LFSRs. They show slightly increased hardware costs with a mostly lower period. The linear complexity, however, can be significantly higher. A disadvantage of such irregularly clocked devices, however, is the fact that due to the irregular clocking, in principle, the output sequence can be inferred by measuring the current in an SPA (SPA =simple power analysis). By using the shift register devices as parts of key generators, which generate data to be kept secret inherently, that is key data, it is of crucial importance for them to be secure against any type of cryptographical attacks.

On the other hand, in such devices, there is the requirement, particularly when they are to be accommodated on chip cards, that the hardware costs have to be low. In other words, the chip area occupied by such devices has to be as small as possible. This is due to the fact that in semiconductor manufacturing the chip area of a whole device, in the end, determines the price and thus the profit margin of the chip manufacturer. Further, particular with chip cards, a specification is such that a customer determines the maximum area of a processor chip in square millimeters, whereon a variety of functionalities have to be accommodated. Thus, it is up to the circuit manufacturer to divide this valuable area between the individual components. With regard to cryptographic algorithms becoming more and more complex, efforts of the chip manufacturer are directed to the chip having the largest amount of memory possible to be able to calculate even algorithms, which are working memory intense, in an acceptable time. Thus, the chip area for key generators and other such components has to be kept as small as possible in order to be able to accommodate a greater amount of memory on the given chip area.

Thus, it is the general requirement for key generators and devices for generating a pseudo random sequence of numbers, respectively, to be secure on the one hand and to require as little space as possible on the other hand, which means to incur the lowest possible hardware costs.

Alternative embodiments for more complex random number generators are shown exemplarily in FIG. 8. FIG. 8 shows a number of linear shift registers, which can, for example, be structured as illustrated with regard to FIG. 7, and which are designated by 81, 82, 83, 84 in FIG. 8. The output signal of every linear shift register 81, 82, 83, 84 designated by 56a, 56b, 56c and 56d is fed into an output stage 85 to finally obtain an output side sequence of numbers at an output 86 of the output stage 85. This combination of several linear feedback shift registers (LFSR) means that the output of several LFSRs serves as input signals for a so-called Boolean combination function, which is implemented by the output stage 85, whose output signal, as has been discussed, will finally be the key sequence.

In the not yet published German patent application with the official document number 102004013481.2-42, filed Mar. 18th, 2004 with the German Patent and Trademark Office, a random number generator is described, where a shift register is provided with a nonlinear feedforward logic. This means that different cells (flip flops) of the underlying shift register are provided with outputs. The outputs of these cells form again the input signals for a nonlinear function. The output signal of this function will then be used as key sequence.

If a linear shift register LFSR is used as underlying shift register, the security of these key generators is not ideal. Attacks on systems, which are based on linear shift registers, have been discovered. These attacks are summarized under the name XL algorithm. XL stands for extended linearization. XL designates a heuristic method for efficiently solving heavily overdefined algebraic equation systems. Overdefined means that there are more equations than unknown variables.

These attacks are illustrated in Shamir, Patarin, Courtois, Klimov: “Efficient Algorithms for Solving Overdefined Systems of Multivariate Polynomial Equations”, Advances in Cryptology EUROCRYPT 2000 (B. Preneel, ed.), Lecture Notes in Computer Science, vol. 1807, pp. 392-407, Springer-Verlag, 2000.

A further important paper is: N. Courtois and W. Meier: Algebraic attacks on stream ciphers with linear feedback, Advances in Cryptology, EUROCRYPT 2003 (E. Biham, ed.), Lecture Notes in Computer Science, vol. 2656, pp. 345-359, Springer-Verlag, 2003.

Thus, linear shift registers should not longer be used for applications requiring a high degree of security.

### SUMMARY OF THE INVENTION

It is an object of the present invention to provide an improved concept for generating random numbers, which is characterized, on the one hand, by security, and, on the other hand, by efficiency.

In accordance with a first aspect, the present invention provides a device for generating a sequence of numbers, having: a first shift register with a nonlinear feedback, a first number of memory cells and a first output coupled to the first number of memory cells by a first coupling means; a second shift register with a nonlinear feedback, a second number of memory cells and a second output coupled to the second number of memory cells by a second coupling means; and a combination means for combining a first data sequence at the first output and a second data sequence at the second output to obtain the sequence of numbers.

In accordance with a second aspect, the present invention provides a method for generating a sequence of numbers, having the steps of: generating a first data sequence with a first shift register with a nonlinear feedback, a first number of memory cells and a first output, which is coupled to the first number of memory cells by a first coupling means; generating a second data sequence with a second shift register with a nonlinear feedback, a second number of memory cells and a second output, which is coupled to the second number of memory cells by a second coupling means; and combining the first data sequence at the first output and the second data sequence at the second output to obtain the sequence of numbers.

In accordance with a third aspect, the present invention provides a computer program with a program code for performing the method for generating a sequence of numbers, having the steps of: generating a first data sequence with a first shift register with a nonlinear feedback, a first number of memory cells and a first output, which is coupled to the first number of memory cells by a first coupling means; generating a second data sequence with a second shift register with a nonlinear feedback, a second number of memory cells and a second output, which is coupled to the second number of memory cells by a second coupling means; and combining the first data sequence at the first output and the second data sequence at the second output to obtain the sequence of numbers, when the computer program runs on a computer.

### BRIEF DESCRIPTION OF THE DRAWINGS

These and other objects and features of the present invention will become clear from the following description taken in conjunction with the accompanying drawings, in which:

FIG. 1 is a device for generating a sequence of numbers according to a preferred embodiment of the present invention;

FIG. 2 is an alternative embodiment of the inventive device for generating a sequence of numbers with an arbitrary number of shift registers with nonlinear feedback and linear feedforward;

FIG. 3 is a detailed representation of a preferred implementation of a shift register;

FIG. 4a is an embodiment of a shift register with nonlinear feedback;

FIG. 4b is an alternative embodiment of a shift register with nonlinear feedback;

FIG. 5a is another shift register with nonlinear feedback;

FIG. 5b is another shift register with nonlinear feedback;

FIG. 6 is a schematical representation of a shift register with general nonlinear feedback function;

FIG. 7 is a prior art shift register with linear feedback; and

FIG. 8 is a combination of linear shift registers.

### DESCRIPTION OF THE PREFERRED EMBODIMENTS

The present invention is based on the knowledge that optimum security on the one hand and high efficiency on the other hand can be achieved when at least two shift registers with nonlinear feedback are used, wherein every shift register with nonlinear feedback has a linear coupling means, which means a linear feedforward, to generate an output data sequence from a shift register with nonlinear feedback, wherein the output data sequences of all shift registers with nonlinear feedback is then combined in a combination means to finally obtain the sequence of numbers.

The usage of several (smaller) shift registers with nonlinear feedback instead of a single (large) shift register with nonlinear feedback allows to save chip area, since the periodicity of the output sequence of two smaller shift registers is equal to the product of the periodicity of the individual shift registers with nonlinear feedback, so that despite using two shift registers with a smaller number of memory cells, a periodicity of the output sequence can be obtained, wherein for achieving the same with a single shift register with nonlinear feedback significantly more memory cells would be required than the sum of memory cells of the individual registers. Thus, the inventive concept is chip area efficient and particularly applicable in a flexible way, since the circuit designer does not require a large spot of the chip to accommodate a large individual shift register. Instead, several small spots on the chip are sufficient, where the several small individual shift registers are disposed, which can finally be combined.

Thus, the concept is more secure in that nonlinear shift registers are used, against which the XL attacks will fail. Above that, it is significantly more difficult for an attacker to detect several small shift registers as a single large shift register by grinding open and inspecting a chip, since the regular structures in a single large shift register are much clearly visible than with several small shift registers, which are preferably not disposed immediately adjacent on the chip, but at different locations on the chip.

In a preferred embodiment of the present invention, individual shift registers are used, which generate periods equal 2^{N}−1, wherein N is the number of memory cells in the shift register. In the case of a finite body, which not only has the numbers 0 and 1, but an arbitrary number q, the period of the preferred shift registers is q^{N}−1. Even slightly smaller periods are acceptable. The maximum achievable periods 2^{N} are not so well suited for the combination and mathematical predictability as slightly shorter periods 2^{N}−1.

In preferred embodiments, the linear coupling means, which means the feedforward means, is effective to multiply the outputs of several individual memory cells in the shift registers with a respective element of the finite body and then to combine them in a linear way, for example by XOR gates or XNOR gates, to provide the output data sequence of the corresponding shift register, which is again fed into the combination means together with the other output data sequences of the other shift registers, to generate the output sequence of numbers from the finite body by an arbitrary way of combining, preferably by Boolean combination elements, such as elementary gates.

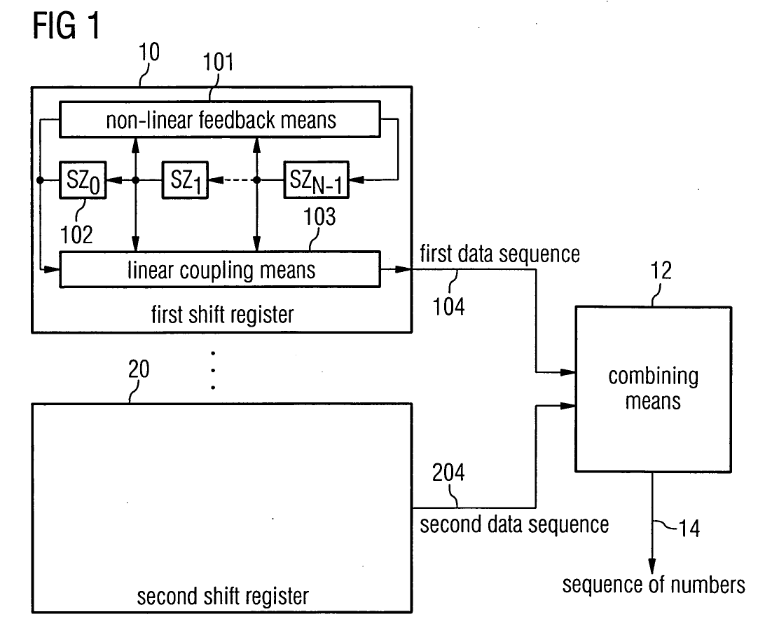

FIG. 1 shows an inventive device for generating a sequence of numbers from a finite body. The device comprises a first shift register 10 with a nonlinear feedback 101 and a first number of N memory cells, wherein, for example, the memory cell SZ₀ is designated by 102. Further, the first register comprises a coupling means 103, which is preferably embodied as linear coupling means, and combines output sequences of the memory cells 102 to generate a first data sequence therefrom at an output 104 of the first shift register, which is the final result of the first shift register 10. The inventive device comprises a second shift register 20 comprising the same elements as described in connection with the first shift register 10, namely a nonlinear feedback means, a number of memory cells as well as coupling means, which is also preferably embodied in an linear way as in the first shift register 10. The second shift register 20 provides a second data sequence at an output 204, which is linked to the first data sequence in a combination means 12, preferably term by term, and in the case of a binary finite body, bit by bit, to generate a sequence of numbers at an output 14 of the inventive number generator means, which is shown in FIG. 1. If the finite body is the binary finite body linked elements 0 and 1, the sequence of numbers at the output 14 will be a sequence of bits. However, if the finite body is a body that can comprise, for example, the numbers 0 to 9, the sequence of numbers at the output 14 will be a sequence of numbers, which can have a value of the values 0 to 9.

The mathematical predictability of the sequence of numbers obtained at the output 14 is best when the shift registers have such a nonlinear feedback characteristic 101, that the periodicity of an output sequence of the memory cell SZᵢ is 2^{N}−1. This again leads to the first data sequence generated by the linear coupling means 103 having the same periodicity.

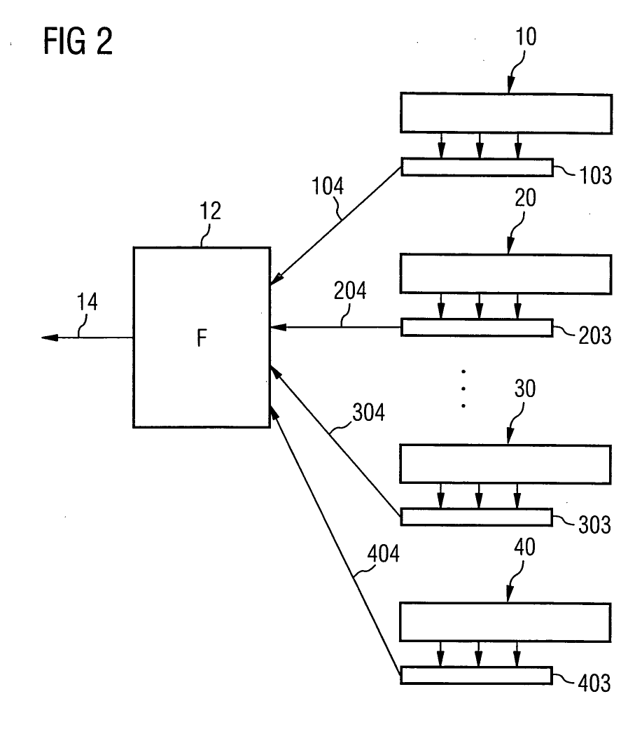

In the embodiment shown in FIG. 2, contrary to FIG. 1, an arbitrary number n of shift registers 10, 20, 30, 40 are coupled to the combination means 12 to combine an arbitrary number of i output data sequences 104, 204, 304, 404 to finally obtain the sequence of numbers at the output 14.

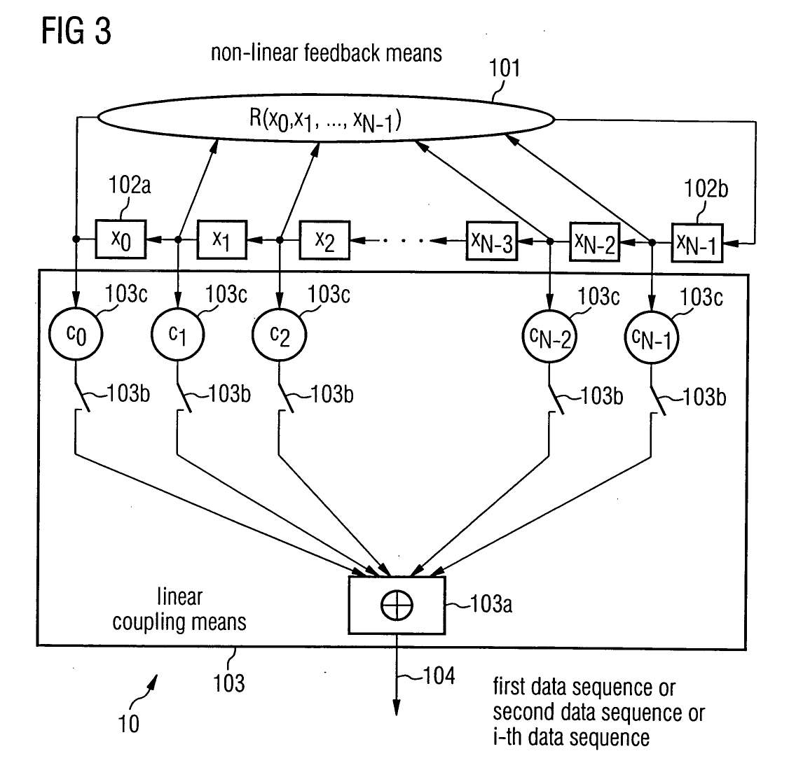

FIG. 3 shows a preferred embodiment of a shift register 10, 20, 30, 40, which can in principle be separated into three different blocks, namely the nonlinear feedback means 101, the sequence of memory cells preferably disposed in a serial way, which extend between a lowest-order memory cell 102a, which is also designated by x₀, and a highest-order memory cell 102b, which is designated by x_{N-1}. Preferably, every output of every memory cell can be connected both with the non-linear feedback means 101 as well as with the linear coupling means 103. The linear combination is performed, for example, by an XOR gate 103a, which could also be designed as XNOR gate, to obtain a linear combination of the input signals. Every input signal comes from a switch 103b, wherein such a switch 103b is provided for every output of a shift register. Further, every output of a memory cell is formed to be multiplied, with an element of the finite body, wherein the multiplier or the weighting means, respectively, 103c is also designated by c₀ to C_{N-1}. c₁ is an element, which is preferably programmed in a fixed way in the shift register 10 in software or preferably hardware, for every memory cell xᵢ. If the finite body is a finite body, which only has elements 0 and 1, cᵢ is either 0 or 1. If, however, the finite body is e.g. the finite body comprising the numbers 0, 1, 2, . . . , 8, 9, cᵢ are each an integer between 0 and 9.

It should be noted that the switches 103b are provided merely preferably. They are to symbolize that the shift register shown in FIG. 3 can be configured from use to use, namely in that, e.g. merely a few of the switches are closed, which means that only the output sequences of several (and not all) memory cells xᵢ are fed into the XOR gate 103a, depending on weighting by the corresponding element cᵢ.

Above that, it is preferred to feed only a number of low-order memory cells after their weighing by the element 103c to the XOR gate, such as the output sequences of the memory cells x₀, x₁, x₂ in FIG. 3, while the output sequences of the memory cells x_{N-1}, x_{N-2} and x_{N-3} are not used in the linear coupling means. Generally, it is preferred to use about 40 to 60% of the low-order memory cells, which means the memory cells on the left hand side in FIG. 3, and to not use the remaining high-order memory cells, which means the remaining 60 to 40% of the high-order memory cells, in the combination by the linear coupling means, which means the gate 103a.

It has been found out that such a sequence, where part of the memory cells is combined by the coupling means, behaves more like a physical random number source than when a data sequence generated at the output of the linear coupling means, which is based on the combination of all memory cells x₀ to x_{N-1}.

This will be illustrated below with regard to a shift register with, e.g., 10 memory cells. Further, it will be assumed that the output sequences of the 5 low-order memory cells are combined as x₀, . . . , x₄ by the XOR gate 103a of FIG. 3. In contrast, the high-order memory cells, which means x₅, . . . , x₉ do not enter the combination. For these memory cells, the switches 103b are open.

Thereby it is achieved that a statistical equidistribution of all tuples occurs in the output data sequence, which have a length equal to the number of combined low-order memory cells. This means that the tuples for k=1, which means all zeros and ones, appear with the same frequency in the first data sequence. Above that, all tuples with k=2, which means (0, 0), (0, 1), (1, 0) and (1, 1) occur with the same frequency in the first data sequence at the output 104. This applies also for the tuples with k=3, k=4 and k=5. However, this does not apply for the tuples with k=6, k=7, k=8, k=9 and k=10. Here, deviations exist within the statistics, how often the respective k tuples appear in the first data sequence at the output 104 of the shift register 10 in FIG. 3. By this actual “deterioration” from the ideal statistic of a data sequence, the artificial nature of the ideally statistical data sequence of the shift register in FIG. 3 becomes “blurred”.

The deliberate introduction of deviations from the ideal statistic for larger tuples ensures that an attacker, when viewing the sequence of numbers, does not immediately see that such a sequence of numbers is provided by a pseudo random number generator and not by a real random number generator, such as a noise source. As has been found out, a real physical random number generator does not have the ideal statistic, but always a deviation from the ideal statistic. Only when the output sequence of a physical random number generator is viewed for a very long time, the output sequence would be of an ideal statistic. However, this only applies when the conditions of the random number generator have not changed, which means e.g. temperature, current, etc. Since the conditions of physical random number generators will most likely change during the viewing time, which means it cannot be guaranteed that a noise source is operated for an indefinite amount of time with the same temperature and with the same current, it can be seen that a deviation from the ideal statistic, which is within a limited (small) frame, does not make the generated sequence of numbers look like a synthetical unreal random number sequence, but like a real random number sequence generated by an actual noise generator.

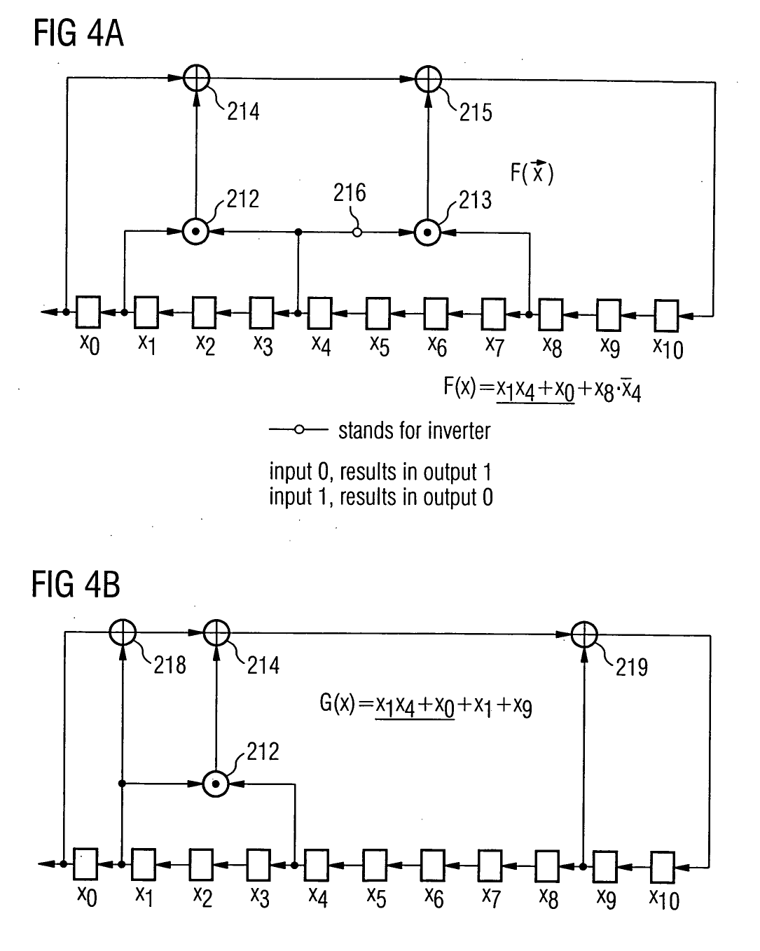

FIG. 4a shows a feedback function F(x) for N=11 memory cells in the feedforward coupling means, wherein F(x) is marked in FIG. 4a and comprises two AND gates 212, 213 and two XOR gates 214 and 215 as well as an inverter 216. Thereby, the feedback characteristic F(x) shown in FIG. 4a can be implemented.

An alternative feedback characteristic G(x) is shown in FIG. 4b together with a possible implementation. It can be seen that the two feedback characteristics F(x) and G(x) share the AND gate 212 and the XOR gate 214. In the embodiment shown in FIG. 4b, another XOR gate 218 as well as a further XOR gate 219 are required. The area of the two equations F(x) and G(x) underlined in FIG. 4a and FIG. 4b show the part x₁ x₄+x₀ shared by the two feedback characteristics, wherein the shared usage of this term serves for saving in hardware.

In the shift register shown in FIG. 4a or FIG. 4b, every output sequence has a period of 2¹¹−1=2047 and a linear complexity of 2¹¹−2=2046 due to the 11 cells of the shift register and due to a preferred nonlinear feedback. The feedback functions are also illustrated, wherein a dash above a symbol means the binary complement.

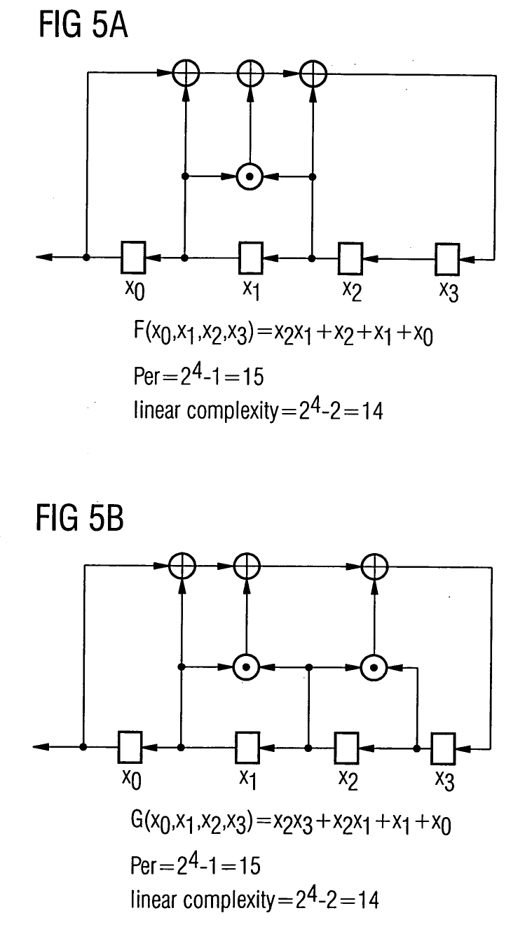

FIGS. 5a and 5b show a further possibility for a 4-cell shift register with two different feedback means F(x) and G(x), which can be implemented based on a change-over switch 203, as shown in FIG. 4. Again, the feedback means is built in the form of the first combination means in FIG. 5a as one AND gate and three XOR gates, while the combination means for the second feedback means, as shown in FIG. 5b comprises again two AND gates and three XOR gates. The “symbiosis” of FIGS. 5a and 5b is shown in FIG. 5c, where again two AND gates and three XOR gates are used together with the change-over switch 203, to activate and deactivate, respectively, the feedback characteristic F(x) and G(x) in dependence on the signal z supplied to the change-over switch 203.

As has already been explained, it is preferred that all shift registers in FIGS. 5a, 5b and 4a, 4b, respectively, are nonlinear, i.e. comprise a nonlinear element, such as, for example, a nonlinear multiplication element, which is an AND gate considered on the logic level.

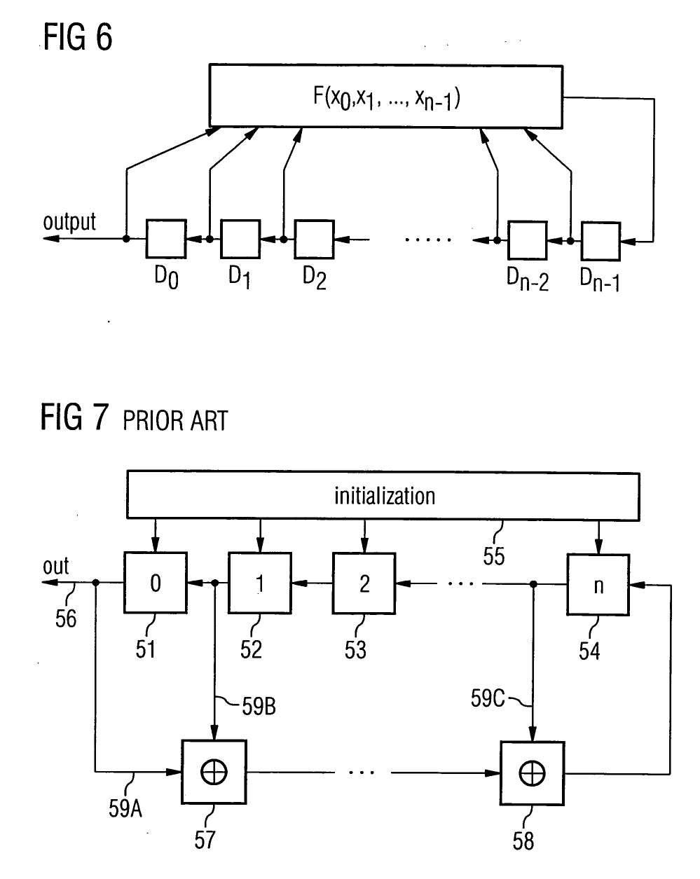

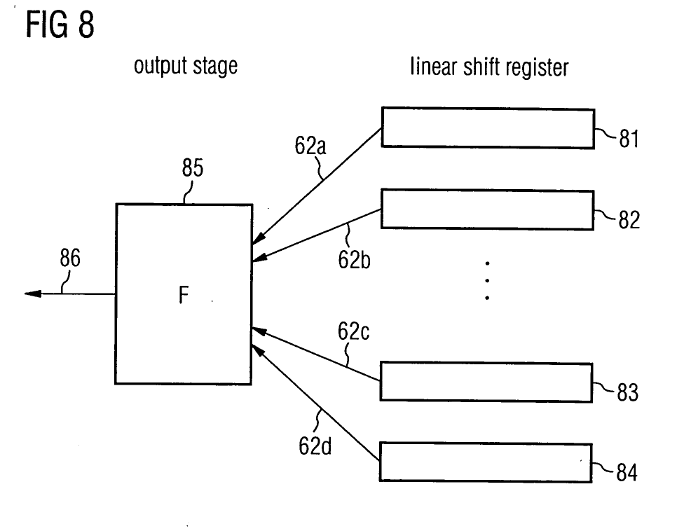

FIG. 6 shows a general feedback shift register with memory cells D₀, . . . , Dₙ₋₁, with a feedforward means as well as with a feedback means designated by F(x₀, x₁, . . . , xₙ₋₁).

A general n-stage (or n-cell) feedback shift register over the base body GF(2)={0,1} will be considered. The shift register consists of n memory cells (flip flops) D₀, D₁, . . . , Dₙ₋₁ and the (electronical) realization of a feedback function F(x₀, x₁, . . . , xₙ₋₁). The feedback function associates an unambiguous value of GF(2), which means the value 0 or 1, to every n tuple consisting of n bits. In mathematical terminology, F is a function with a definition domain GF(2)ⁿ and a target domain GF(2).

The shift register is controlled by an external clock. The content of the memory cell Dⱼ is shifted to the left adjacent cell Dⱼ₋₁ with each clock rate. 1≦j≦n−1. The content of the memory cell D₀ is output. If the contents of the memory cells D₀, D₁, . . . , Dₙ₋₂, Dₙ₋₁ at a time t are given by
sₜ, sₜ₊₁ . . . sₜ₊ₙ₋₂, sₜ₊ₙ₋₁
then, one clock rate later, which means at a time t+1, the memory cells will contain the bits
sₜ₊₁, sₜ₊₂, . . . , sₜ₊ₙ₋₁, sₜ₊ₙ,
wherein the value sₜ₊ₙ that has entered the cell Dₙ₋₁ is given by
sₜ₊ₙ=F(sₜ, sₜ₊₁, sₜ₊ₙ₋₁).

The n-tuple (sₜ, sₜ₊₁, . . . , sₜ₊ₙ₋₁) describes the state of the shift register at the time t. The n tuple (s₀, s₁, . . . , sₙ₋₁) is called the initial state. FSR(F) is used as abbreviation for the general feedback shift register having a feedback function F (FSR stands for feedback shift register). FIG. 6 shows a general feedback shift register.

The shift register outputs one bit with each clock of the external clock. In that way, the shift register can produce a periodic bit sequence s₀, s₁, s₂, . . . , a so-called shift register sequence. Let s₀, s₁, . . . , sₙ₋₁ be the initial values of the shift register sequence. The feedback function F(x₀, x₁, . . . , xₙ₋₁) and the initial values s₀, s₁, . . . , sₙ₋₁ completely determine the shift register sequence. Since there are only 2ⁿ different states for the shift register, the period of the shift register sequence s₀, s₁, s₂, . . . is at most 2ⁿ.

A general feedback shift register FSR(F) will be called homogeneous if its feedback function F is homogenous, i.e. if F(0, 0, . . . , 0)=0 applies. A homogeneous shift register put in the initial state s₀=s₁= . . . =sₙ₋₁=0 will produce the null sequence. It follows that the period of the output sequence of an n stage homogenous shift register can be at most 2ⁿ−1. If the period takes on the maximum value 2ⁿ−1, the shift register sequence is called an M sequence and the shift register is maximum. It is an important task to find maximum shift registers.

Two special cases of the general feedback shift register FSR(F) are of particular interest. In one case, the feedback function F has the form:

$$F ( {x}_{0} , {x}_{1} , … , {x}_{n - 1} ) = {\sum }_{0 \leq i \leq j \leq n - 1} {a}_{ij} {x}_{i} {x}_{j}$$

wherein the coefficients aᵢⱼ are either 0 or 1. In that case, this is called a square feedback function as an example for a nonlinear feedback function and the term square applies also to the shift register.

The other special case occurs when the feedback function F is linear. Then F has the following form:
F(x₀, x₁, . . . , xₙ₁)=a₀x₀+a₁x₁+ . . . +aₙ₋₁xₙ₋₁,
wherein the occurring coefficients aᵢ are again equal to 0 or 1, which means elements of GF(2). In this case, this is called a linear or linear feedback shift register and the abbreviation LFSR (linear feedback shift register) is used therefore. It is to be noted that both the linear feedback and the square feedback shift registers are homogenous.

An n-stage linear feedback shift register is usually characterized by a binary polynomial f(x) of the degree n in a variable x. This polynomial f is called the characteristic polynomial of the linear feedback shift register. The shift register is then written as LFSR(f).

The feedback function F(x₀, x₁, . . . , xₙ₋₁) of a linear feedback shift register is a polynomial in n variables x₀, x₁, . . . , xₙ₋₁ and of the degree 1. In contrast, the characteristic polynomial f(x) of the same linear shift register is a polynomial with only one variable, namely the x, but of the degree n. It applies:
f(x)=xⁿ+F(1, x, x², . . . , xⁿ⁻¹)

Thus, the nonlinearity of the feedback function can be performed by relatively arbitrary forms of the feedback function F. Therefore, it will basically be sufficient to merely multiply the output signals of two memory cells Dᵢ and Dᵢ₊₁, which would result in a square shift register. Of course, more than two memory cell outputs can be multiplied or be subjected to any nonlinear function. In principle, however, a feedback can also be performed with only one output signal of a single memory cell, for example by merely feeding back the output signal of the memory cell D₀, feeding the same into the function F(x₀) and feeding the output signal of this function, e.g. into the memory cell Dₙ₋₁ on the input side. Such a nonlinear function with only a single value would, for example, be an inversion, which means a logic NOT function. However, the nonlinear function could also be any other function, for example a nonlinear association function or a cryptographic function.

As has already been explained, the inventive device for generating a long sequence of bits or in more general terms, of elements from a finite body, is advantageous in that it requires, on the one hand, only relatively low hardware cost and, on the other hand, generates sequences with favorable characteristics. Such favorable characteristics are a long period, a high linear complexity, good distribution characteristics, an ideal polynomial complexity (maximum or complexity). Thus, the inventive device for generating key sequences is also suitable for the usage in a stream cipher. Further, it can also be used as parameterizable pseudo random number generator (PRNG).

As has already been discussed, the inventive solution is based on nonlinear feedback shift registers (NLFSR). Therefore, preferably, such NLFSRs are used, which have a feedback function, which can be described by relatively sparsely occupied recursion formulas, which leads to an inexpensive realization in hardware by the low number of gates. Further, such shift registers with nonlinear feedback are preferred, whose output sequences have a long period. With regard to the sparsely occupied recursion formula it should be noted that such recursion formulas are preferred, where the states of less than half or equal to half of the memory cells are entered. Thus, in a shift register with about 10 memory cells, merely the respective output sequences of 5 memory cells or less than 5 memory cells would enter the nonlinear feedback function.

If an inventive nonlinear shift register has exactly N flip flops (as design of a memory cell), the output sequence can have a maximum period of 2^{N}, when the binary case is considered, or q^{N} in the general case of an underlying finite body of the order=amount q. Shift registers of this maximum possible period however, are only suboptimal for the present invention. It is preferred to use shift registers with nonlinear feedback, whose generated sequences are smaller than the maximum possible sequence, which means shift registers with nonlinear feedback generating sequences of the period 2^{N}−1 and q^{N}−1, respectively, wherein slightly smaller periods are still preferred, namely for example periods, which are longer or equal to 2^{N}−1.

According to the invention, such a nonlinear shift register with N flip flops comprises N outputs. As shown with regard to FIG. 3, every output can be provided with a switch that can be opened or closed. If all switches are closed, N output sequences exist. These are multiplied term by term with a finite body element cᵢ, and the sequences generated in that way are linked via an XOR gate 103a.

In other words, the nonlinear shift register is provided with a parameterizable linear feedforward function. The inventive number generator device consists of several shift registers with nonlinear feedback, whose length are preferably prime in pairs. This means that the greatest common divisor between the two numbers N, M of two shift registers 10, 20 (FIG. 1) is at the most equal to 1. Every shift register with nonlinear feedback further has a parameterizable linear feedforward logic. The output sequences of the different feedforward logics are then combined to the final key sequence and pseudo random sequence, respectively, with the help of the Boolean combination function, which is preferably present in the combination means 12 (FIG. 1).

The inventive concept, which means the inventive device, the inventive method and the inventive computer program have the following advantages:

The device is immune against attacks using the XL algorithm (see point 2).

The device is parameterizable: The occupancy of the cells of all occurring NLFSRs makes up the cryptographical key (or the seed in the context of a pseudo random number generation). The position of the switches of the outputs from the cells of the individual NLFSRs makes up the parameterizability.

It can be proved that the output sequences from the feedforward logic of such an NLFSR have generally the same long period and the same (high) linear complexity as the direct output sequence from the NLFSR.

It can also be proved that the output sequences from the feedforward logic have good statistical characteristics, provided that only about the first half of the cells of the NLFSR is output and fed to the linear feedforward logic. Then, the output sequences have the same amount of zeros and ones in the binary case. The pairs (0, 0) (0, 1), (1, 0) and (1, 1) also with the same frequency within one period. The same applies for all possible k tuples, as long as k is not higher than N/2. These ideal distribution characteristics apply also in the general case of a finite body of the order q in corresponding manner.

The output sequences from the feedforward logics have generally the ideal value of the maximum order complexity. When the NLFSR has exactly N cells, then the direct output sequence has the maximum order complexity N. By contrast, the output sequences from the feedforward function have generally the maximum order complexity N/2 (a real random sequence of the length 2^{N} would also very likely have the maximum order complexity 2N).

Thus, preferably, the inventive number generators have specific nonlinear feedback shift registers with configurable feedforward logics, whose output sequences are then combined term by term with the help of a Boolean combination function to generate the final sequence. This sequence is then used for encrypting in the sense of Vigenere chiffre or serves as pseudo random number for other things than the encryption, namely for simulation purposes, etc.

As has already been discussed, the inventive device can generate sequences of elements from a finite body F_{q}. For the important specific case, q=2 applies, i.e. F_{q}=F₂=GF(2). The elements of the finite body F₂ are 0 or 1, which means bits in the binary case.

In the figures, the feedback functions are shown from F_{q}^{N} to F_{q}. This means that the feedback logic can be represented by arithmetic operations in the finite body F_{q}. Here, N is the number of memory cells of a shift register. N means also the length of the shift register. Every memory cell can store an element from F_{q}.

As has been explained, such nonlinear shift registers are used as a base, whose direct output sequences have the period q^{N}−1, wherein N is the length of the shift register. Further, it is preferred that the lengths of the shift registers are prime in pairs. Further, a linear feedforward logic is preferred. If all switches are closed, the following applies:
V(x₀, x₁, . . . , x_{N-1})=c₀x₀+c₁x₁+ . . . +c_{N-1}x_{N-1}.

The coefficients c₀, c₁, . . . , c_{N-1} are elements from F_{q}. Depending on the circumstances, the inventive method for generating a sequence of numbers can be implemented in hardware or in software. The implementation can be effected on a digital memory media, particularly a disc or CD with electronically readable control signals, which can cooperate with a programmable computer system such that the method is performed. Thus, generally, the invention consists also of a computer program product with a program code stored on a machine readable carrier for performing the inventive method when the computer program product runs on a computer. In other words, the invention can thus be realized as computer program with a program code for performing the method when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A device for generating a sequence of numbers, comprising:
a first shift register with a nonlinear feedback, a first number of memory cells and a first output coupled to the first number of memory cells by a first coupler;
a second shift register with a nonlinear feedback, a second number of memory cells and a second output coupled to the second number of memory cells by a second coupler; and
a combiner for combining a first data sequence at the first output and a second data sequence at the second output to obtain the sequence of numbers.

2. The device according to claim 1, wherein the first coupler and/or the second coupler is a linear coupler.

3. The device according to claim 1, wherein the first shift register and/or the second shift register is formed such that the first number of memory cells and the second number of memory cells are prime.

4. The device according to claim 1, wherein each of the first number and the second number is greater or equal to 5.

5. The device according to claim 1, wherein the first shift register and/or the second shift register is formed such that an output sequence of the shift register at a memory cell has a period, which is less than or equal to 2^{N}−1, where N is the number of memory cells of the shift register.

6. The device according to claim 1, wherein the first shift register and/or the second shift register is formed such that an output sequence of the shift register has a period, which is greater than or equal to 2^{N}−1, where N is the number of memory cells of the shift register.

7. The device according to claim 1, wherein the first shift register and/or the second shift register is formed to comprise a feedbacker, which is formed to combine outputs of at least two memory cells of the shift register.

8. The device according to claim 7, wherein the feedbacker is formed to combine outputs of less than or equal to N/2 memory cells, where N is the number of memory cells of the shift register.

9. The device according to claim 1, wherein the first coupler and/or the second coupler is formed to couple output sequences of at least two memory cells or sequences derived from the output sequences of at least two memory cells.

10. The device according to claim 9, wherein the first coupler and/or the second coupler is formed to couple the output sequences or the sequences derived from the output sequences bit by bit by an XOR gate or an XNOR gate to obtain the sequence of numbers.

11. The device according to claim 9, wherein the first shift register and/or the second shift register is formed such that the memory cells are connected in series, wherein a low-order memory cell and a high-order memory cell exist, wherein the output of the nonlinear feedback is coupled to an input of the high-order memory cell, and wherein the coupler is formed to couple only low-order memory cells but not high-order memory cells to each other.

12. The device according to claim 11, wherein at least one of the first and second couplers is formed to couple at most N-3 or less high-order memory cells to each other and to not couple at least three low-order memory cells.

13. The device according to claim 1, wherein at least one of the first and second couplers is formed to weigh an output sequence of a memory cell with a number from a finite body, where the sequence of numbers is defined.

14. The device according to claim 9, wherein at least one of the first and second couplers is formed to weigh an output sequence with a number from the finite body to obtain the sequence of numbers derived from the output sequence.

15. The device according to claim 13, wherein the first coupler and/or the second coupler is formed to use a fixed number for the sequence of numbers for weighing purposes.

16. The device according to claim 1, wherein the combiner is formed to link the first data sequence at the first output and the second data sequence at the second output term by term by a Boolean combination function.

17. The device according to claim 16, wherein the first data sequence and the second data sequence are binary, and wherein the combiner is formed to use at least one gate selected from the group consisting of an AND gate, a NAND gate, a OR gate, a NOR gate, an XOR gate and an XNOR gate.

18. The device according to claim 1, wherein at least one of the first and second couplers is formed to have a switch for a memory cell, to use output sequences of the memory cells dependent on a control signal for the switch for coupling purposes or not.

19. A method for generating a sequence of numbers, comprising the steps of:
generating a first data sequence with a first shift register with a nonlinear feedback, a first number of memory cells and a first output, which is coupled to the first number of memory cells by a first coupler;
generating a second data sequence with a second shift register with a nonlinear feedback, a second number of memory cells and a second output, which is coupled to the second number of memory cells by a second coupler; and
combining the first data sequence at the first output and the second data sequence at the second output to obtain the sequence of numbers.

20. A computer program with a program code for performing a method for generating a sequence of numbers, comprising the steps of:
generating a first data sequence with a first shift register with a nonlinear feedback, a first number of memory cells and a first output, which is coupled to the first number of memory cells by a first coupler;
generating a second data sequence with a second shift register with a nonlinear feedback, a second number of memory cells and a second output, which is coupled to the second number of memory cells by a second coupler; and
combining the first data sequence at the first output and the second data sequence at the second output to obtain the sequence of numbers,
when the computer program runs on a computer.

21. A device for generating a sequence of numbers, comprising:
a first shift register means with a nonlinear feedback means, a first number of memory cells and a first output coupled to the first number of memory cells by a first coupling means;
a second shift register means with a nonlinear feedback means, a second number of memory cells and a second output coupled to the second number of memory cells by a second coupling means; and
a combining means for combining a first data sequence at the first output and a second data sequence at the second output to obtain the sequence of numbers.
